(19) United States
(12) Patent Application Publication
(10) Pub. No.: US 2010/0295993 A1
(43) Pub. Date: Nov. 25, 2010

(54) APPARATUS AND METHOD FOR SYNCHRONIZATION BETWEEN VIDEO AND AUDIO IN MOBILE COMMUNICATION TERMINAL

(75) Inventor: Kyu-Bong Oh, Seongnam-si (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/783,756

(22) Filed: May 20, 2010

(30) Foreign Application Priority Data
May 20, 2009 (KR) 10-2009-0043848

(51) Int. Cl. H04N 5/06

(52) U.S. Cl. 348/516; 348/E05.011

(57) ABSTRACT

An apparatus and a method for synchronization between video and audio in a mobile communication terminal are provided. The method for the synchronization between the video data and the audio data in the mobile communication terminal includes acquiring Presentation Time Stamp (PTS) information for each of audio data and video data which need to be played simultaneously; determining a delay time between the terminal and a wireless device which plays one data of the audio data and the video data; generating new PTS information for the one data by reflecting the determined delay time in the PTS information; and synchronizing the one data and the other data using the new PTS information for the one data and the acquired PTS information for the other data.

### CLAIM OF PRIORITY

The present application claims, under 35 U.S.C. §119(a), priority to and the benefit of the earlier filing date of, that Korean patent application filed in the Korean Intellectual Property Office on May 20, 2009, and assigned Serial No. 10-2009-0043848, the entire disclosure of which is hereby incorporated by reference.

### TECHNICAL FIELD OF THE INVENTION

The present invention relates to the field of mobile communications and more particularly, to an apparatus and a method for providing synchronization between the video and the audio in a mobile communication terminal.

### BACKGROUND OF THE INVENTION

As computers, electronics, and information communication technologies advance, it is possible to reproduce multimedia content, such as video, not only in a stationary space, such as house or office, but also while in a mobile situation. In this regard, players such as Portable Multimedia Player (PMP) and mobile communication terminals, capable of playing video files are widely used. Thus, users can view Digital Multimedia Broadcasting (DMB) or play video files using those players.

To play DMB data or a video file requiring the simultaneous playing of video data and audio data, the synchronization between the video data and the audio data is necessary. Present-day mobile communication terminals utilize Presentation Time Stamp (PTS) information of the video data and the audio data for the synchronization between the video data and the audio data. The PTS information, which is information indicating a play time of the data, indicates time synchronization information when the video data and the audio data are played. In the video file. Typically, the PTS information can be detected in the video file. In the DMB data, the PTS information can be received from a network. That is, the mobile communication terminal can acquire the synchronization by matching the play time of the video data and the audio data with the data play time indicated by the PTS information of the corresponding data.

As such, when the audio data and the video data are synchronized using the PTS information, it is not that hard to simultaneously play both of the video data and the audio data in the mobile communication terminal. However, when only one of the video data and the audio data is played in the mobile communication terminal and the other is played using a wireless device supporting a wireless technology (e.g., Bluetooth), the audio data and the video data are not synchronized because of a delay factor according to the wireless technology. That is, since the audio delay factor inevitably caused by the audio data wirelessly transmitted is not reflected in the synchronization of the video data and the audio data, the play time between the video data and the audio data differs.

### SUMMARY OF THE INVENTION

To address the above-discussed deficiencies of the prior art, it is a primary aspect of the present invention to provide an apparatus and a method for synchronization between video and audio in a mobile communication terminal.

Another aspect of the present invention is to provide an apparatus and a method for, when it is necessary to reproduce video data and audio data at the same time, as in Digital Multimedia Broadcasting (DMB) view or video file play, a terminal itself plays the video data, and a wireless device which supports a wireless technology, such as Bluetooth, plays the audio data, synchronizing the video data and the audio data in a mobile communication terminal.

Still another aspect of the present invention is to provide an apparatus and a method for, when audio data is played using a wireless device supporting a wireless technology, such as Bluetooth, transmitting a polling packet to the wireless device, measuring a time of transmission, receiving a reply packet from the wireless device, measuring a time of reception, and thus periodically determining an audio delay factor between a terminal and the wireless device, in a mobile communication terminal.

Yet another aspect of the present invention is to provide an apparatus and a method for handling an audio delay problem caused by use of a wireless technology by taking into account an audio delay factor according to the wireless technology, in synchronization between video and audio, in a mobile communication terminal.

According to one aspect of the present invention, a method for synchronization between video and audio in a mobile communication terminal includes acquiring Presentation Time Stamp (PTS) information for each of audio data and video data which need to be played simultaneously, the PTS information indicating a play time of the corresponding data; determining a delay time between the terminal and a wireless device which plays one data of the audio data and the video data; generating new PTS information for the one data by reflecting the determined delay time in the acquired PTS information; and outputting the one data and the other data using the new PTS information for the one data and the PTS information for the other data, respectively, wherein the one data and the other data are synchronized.

According to another aspect of the present invention, an apparatus for synchronization between video data and audio data in a mobile communication terminal includes a synchronizer for acquiring PTS information for each of audio data and video data, the PTS information indicating a play time of the corresponding data, determining a delay time between the terminal and a wireless device that plays one data of the audio data and the video data, generating new PTS information for the one data by reflecting the determined delay time in the acquired PTS information, and synchronizing the one data and the other data using the new PTS information for the one data and the acquired PTS information for the other data, respectively; a wireless transceiver for transmitting the one data to the wireless device; and a player for playing the other data in the terminal, wherein the one data and the other data are synchronized.

In one aspect of the invention, a portable terminal comprises: a wireless transmitter including an interface; and a processor in communication with a memory, the memory including code which when accessed by the processor causes the processor to: acquire PTS information associated with video data and audio data to be viewed, the PTS information providing timing information for outputting corresponding video data and audio data; transmit, through the transmitter, a polling packet; receive, through the transmitter, a reply packet in response to poll packet; determine a delay time between a time of poll packet transmission and the time of receipt of the reply packet; adjust the acquired PTS information timing based on the determined delay time; and output one of the video data and the audio data at the acquired PTS information time and output the other one of the video data and the audio data at the adjusted PTS information time.

Other aspects, advantages, and salient features of the invention will become apparent to those skilled in the art from the following detailed description, which, taken in conjunction with the annexed drawings, discloses exemplary embodiments of the invention.

Before undertaking the detailed description of the invention below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a mobile communication terminal and a wireless device according to an exemplary embodiment of the present invention; and

FIG. 2 is a flowchart of a method for synchronization between video and audio in the mobile communication terminal according to an exemplary embodiment of the present invention.

Throughout the drawings, like reference numerals will be understood to refer to like parts, components and structures.

### DETAILED DESCRIPTION OF THE INVENTION

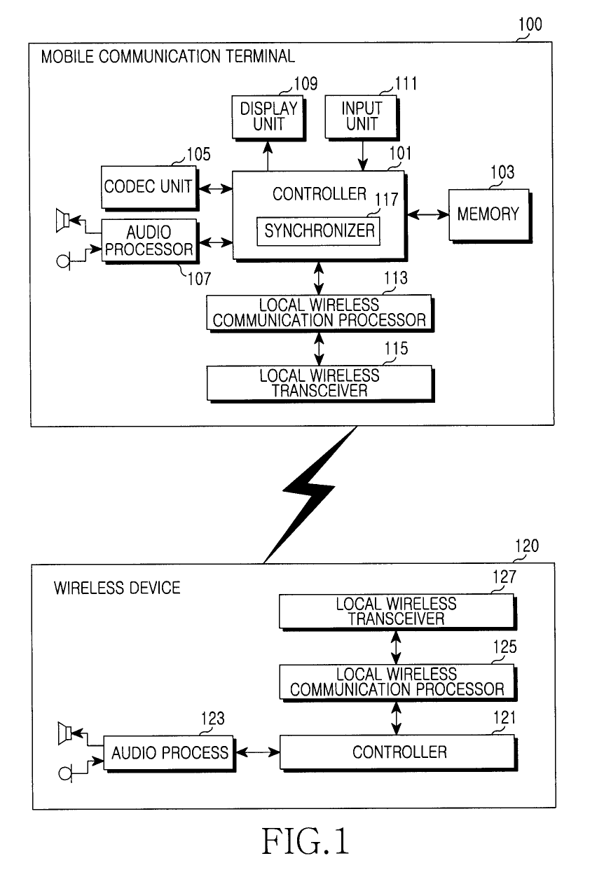

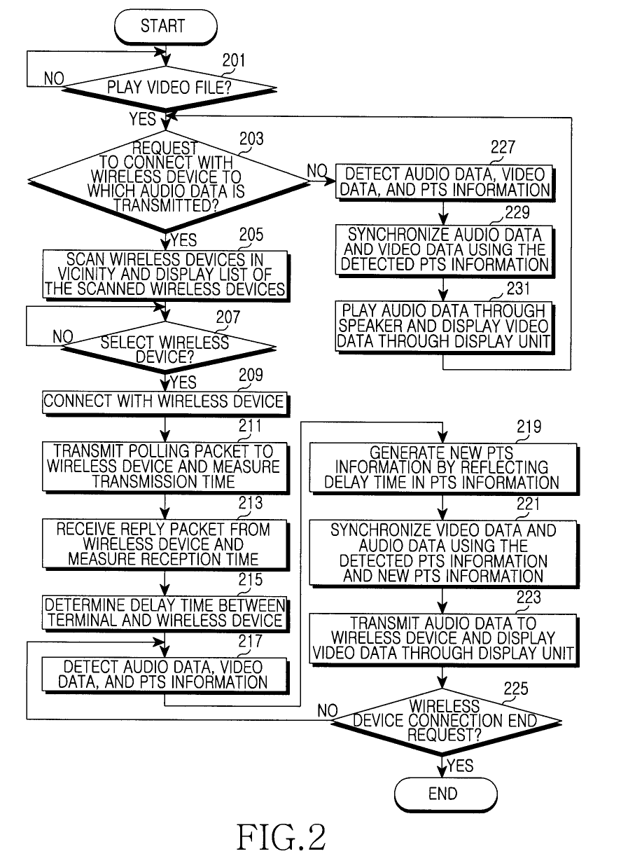

FIGS. 1 and 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communications terminal.

Exemplary embodiments of the present invention provide an apparatus and a method for synchronization between video and audio in a mobile communication terminal. In particular, the present invention provides an apparatus and a method for, when it is necessary to reproduce video data and audio data at the same time, as in Digital Multimedia Broadcasting (DMB) view or video file play, a terminal itself plays the video data, and a wireless device which supports a wireless technology, such as Bluetooth, plays the audio data, taking into account an audio delay factor according to a wireless technology in synchronization between the video and the audio in a mobile communication terminal.

In the following, a mobile communication terminal represents a cellular phone, a Personal Communication System (PCS), a Personal Data Assistant (PDA), International Mobile Telecommunication (IMT)-2000 terminal, and so forth, and a typical structure of the exemplary terminals shall be explained. The mobile communication terminal and the wireless device support wireless technologies, and the wireless technologies include Bluetooth, infrared communication (IrDA), ZigBee, and so on. Bluetooth, IrDA and ZigBee are well-known wireless communication protocols and a detailed discussion of their operation would be known, and readily available, to those skilled in the art.

Hereinafter, the present invention is applicable to every device for playing one of video data and audio data requiring their simultaneous play, using a wireless device one data and playing the other data by itself in a terminal. A synchronization method between the audio data and the video data is applicable when the wireless device plays the audio data and the terminal itself plays the video data and vice versa.

FIG. 1 is a block diagram of a mobile communication terminal and a wireless device according to an exemplary embodiment of the present invention.

The mobile communication terminal 100 of FIG. 1 includes a controller 101, a memory 103, a Coder-Decoder (CODEC) unit 105, an audio processor 107, a display unit 109, an input unit 111, a local wireless communication processor 113, and a local wireless transceiver 115. The controller 101 includes a synchronizer 117. The wireless device 120 includes a controller 121, an audio processor 123, a local wireless communication processor 125, and a local wireless transceiver 127.

In the mobile communication terminal 100 of FIG. 1, the controller 101 controls operations of the mobile communication terminal 100. In addition to typical functions that are operable in a communication terminal, when the simultaneous play of video data and audio data is required, as in DMB view or video file play, the video data is played by the terminal itself, and the audio data is played by the wireless device 120 supporting the wireless technology, the controller 101 functions to take into account an audio delay factor according to the wireless technology in the synchronization between the video and the audio.

The controller 101 includes the synchronizer 117. When the simultaneous play of the video data and the audio data is required, as in DMB view or video file play, the synchronizer 117 outputs the corresponding video data and audio data to the CODEC unit 105 and synchronizes video data and audio data decoded by the CODEC unit 105 using Presentation Time Stamp (PTS) information. The PTS information, which is information indicating a play time of data, indicates time synchronization information when the video data and the audio data are played. In a video file, the PTS information may be found together with the video data and the audio data in the corresponding file. In a DMB system, the PTS information may be obtained from a network. Next, the synchronizer 117 outputs the synchronized audio data to the audio processor 107 and outputs the synchronized video data to the display unit 109.

When the video data is played by the terminal itself and the audio data is played by the wireless device 120 supporting the wireless technology, the synchronizer 117 transmits a polling packet to the wireless device 120, measures a time of transmission, receives a reply packet from the wireless device 120, measures a time of reception, and thus periodically determines a delay time between the terminal 100 and the wireless device 120. The polling packet indicates a packet randomly transmitted to which a reply packet may be received Next, the synchronizer 117 generates new PTS information for the audio data by reflecting the determined delay time in the PTS information, synchronizes the video data and the audio data using the PTS information and the new PTS information, outputs the synchronized audio data to the wireless device 120 via the local wireless communication processor 113 and the local wireless transceiver 115, and outputs the synchronized video data to the display unit 109.

The memory 103 stores microcode of programs and various reference data for the processing and the controlling of the controller 101. In particular, when it is necessary to simultaneously play the video data and the audio data, as in DMB view or video file play, the video data is played by the terminal itself, and the audio data is played by the wireless device 120 supporting the wireless technology, the memory 103 stores a program for taking into account the audio delay factor according to the wireless technology in the synchronization between the video and the audio. The memory 103 stores temporary data generated during the program(s) executions, and updatable data to store, for example, video files.

The CODEC unit 105 encodes the packet data, the video data, or the audio data input from the controller 101 in a set scheme. The CODEC unit 105 decodes an encoded packet data, video data, or audio data to an original packet data, video data, or audio data, respectively, and outputs the decoded (original) data to the controller 101.

The audio processor 107 converts the audio data input from the controller 101 to an audible sound and plays the sound through a speaker, or converts an audio signal generated from a microphone to audio data and outputs the audio data to the controller 101. In so doing, the controller 101 outputs the audio data to the CODEC unit 105.

The display unit 109 displays status information, a limited number of letters, videos, and still images generated in the operations of the mobile communication terminal 100. The display unit 109 may employ a color Liquid Crystal Display (LCD) or similar display devices (e.g., LED, OLED).

The input unit 111 includes numeral key buttons 0 through 9 and a plurality of function keys, and provides the controller 101 with key input data corresponding to the key pressed by the user.

The local wireless communication processor 113 is an interface device between the controller 101 and the local wireless transceiver 115. The local wireless communication processor 113 encodes the signal input from the controller 101 and transmits the encoded signal to the local wireless transceiver 115, and decodes a signal received from the local wireless transceiver 115, and outputs the decoded signal to the controller 101.

The local wireless transceiver 115 transmits the signal input from the local wireless communication processor 113 to the wireless device 120 using a wireless technology such as Bluetooth, infrared communications (IrDA), and ZigBee, and forwards the signal received from the wireless device 120 using the wireless technology to the local wireless communication processor 113. Herein, when the infrared communication of the local wireless communications is used, a transmitter may use an IrDA Light Emitting Diode (LED) and a receiver may use an IrDA photo diode.

In the wireless device 120, the controller 121 controls operations of the wireless device 120. In addition to typical functions, the controller 121 outputs the synchronized audio data received from the mobile communication terminal 100 via the local wireless transceiver 127 and the local wireless communication processor 125, to the audio processor 123 to thus play the audio data.

The local wireless transceiver 127, the local wireless communication processor 125, and the audio processor 123 of the wireless device 120 function the same as the local wireless transceiver 115, the local wireless communication processor 113, and the audio processor 107 of the mobile communication terminal 100, and thus their operations need not be repeated herein.

FIG. 2 is a flowchart of a method for synchronization between the video and the audio in the mobile communication terminal according to an exemplary embodiment of the present invention.

In step 201, the terminal determines whether a video file play menu is selected by the user's key manipulation. That is, the terminal determines whether or not a menu requiring the simultaneous playing of video data and the audio data is selected. Alternatively, the terminal may determine whether a DMB view menu is selected.

When the video file play menu is selected in step 201, the terminal determines whether a connection request of a wireless device to which the audio data of the corresponding video file is to be transmitted is detected in step 203. That is, the terminal determines whether a request to play the video data in the terminal and to play the audio data using the wireless device is detected.

When detecting the connection request of the wireless device in step 203, the terminal scans wireless devices in the vicinity and displays a list of the scanned wireless devices in the display unit in step 205 and then goes to step 207. Scanning for wireless devices, e.g., BLUETOOTH, are processes that that well-known in the art and need not be described in detail herein.

In step 207, the terminal determines whether one of the wireless devices in the displayed list is selected.

When one wireless device is selected in step 207, the terminal connects with the selected wireless device in step 209.

In step 211, the terminal transmits the polling packet to the connected wireless device and measures the time of transmission of the polling packet

In step 213, the terminal receives the reply packet from the connected wireless device and measures the time of reception of the reply packet.

In step 215, the terminal determines the delay time between the terminal and the wireless device based on the measured time of transmission of the polling packet and time of reception of the reply packet. Herein, the delay time between the terminal and the wireless device may be acquired by determining a difference between the measured time of reception and the measured time of transmission and dividing the difference by two.

In step 217, the terminal detects the audio data, the video data, and the PTS information by decoding the video file to play. Alternatively, in case of the viewing a DMB file, the PTS information is received from the network.

In step 219, the terminal generates new PTS information for the audio data by reflecting the determined delay time in the PTS information. The new PTS information is generated by subtracting the determined delay time from the data play time indicated by the PTS information.

In step 221, the terminal synchronizes the detected video data and audio data using the PTS information and the newly generated PTS information. In more detail, the terminal matches the play time of the video data to the data play time indicated by the PTS information, and matches the play time of the audio data to the data play time indicated by the newly generated PTS information.

In step 223, the terminal transmits the synchronized audio data to the wireless device and displays the video data through the display unit. The wireless device plays the synchronized audio data using an internal speaker or an earphone. As such, by taking into account the audio delay factor according to the wireless technology in the synchronization between the video and the audio, the user may perceive the playing of the audio data through the wireless device in the synchronization with viewing the video data.

In step 225, the terminal determines whether a connection end request with the wireless device is detected.

When not detecting the connection end request with the wireless device in step 225, the terminal returns to step 217 and repeats the subsequent step.

By contrast, upon detecting the connection end request with the wireless device in step 225, the terminal finishes this process.

Returning to step 203, when the connection request of the wireless device to which the audio data is to be transmitted is not detected, the terminal detects the audio data, the video data, and the PTS information by decoding the video file to play in step 227. Alternatively, in case of a viewing of DMB data, the PTS information is received from the network.

In step 229, the terminal synchronizes the detected video data and audio data using the PTS information. That is, the terminal matches the play time of the video data and the audio data to the data play time indicated by the PTS information.

In step 231, the terminal plays the synchronized audio data through its internal speaker or an earphone (not shown) and displays the video data through the display unit. Next, the terminal goes back to step 203 and repeats the subsequent step.

In one aspect of the invention, the terminal periodically determines the delay time between the terminal and the wireless device and reflects the delay time in the PTS information. Thus, it is possible to continuously manage the additional delay factors which may occur when the terminal and the wireless device are spaced farther.

As set forth above, when it is necessary to reproduce the video data and the audio data at the same time at the mobile communication terminal, as in DMB view or video file play, the terminal itself plays the video data, and the wireless device supporting the wireless technology plays the audio data, the mobile communication terminal takes into account the audio delay factor according to the wireless technology in the synchronization between the video and the audio. Therefore, the audio delay problem inevitably caused by the use of the wireless technology can be enhanced.

The above-described methods according to the present invention can be realized in the controller(s) in hardware or as software or computer code that can be stored in a recording medium such as a CD ROM, an RAM, a floppy disk, a hard disk, or a magneto-optical disk or downloaded over a network (i.e., The computer program can be provided from an external source which is electronically downloaded over a network, e.g., Internet, POTS, so that the methods described herein can be rendered in such software using a general purpose computer, or a special processor or in programmable or dedicated hardware, such as an ASIC or FPGA. As would be understood in the art, the controller(s), computer, the processor or the programmable hardware include memory components, e.g., RAM, ROM, Flash, etc. that may store or receive software or computer code that when accessed and executed by the computer, processor or hardware implement the processing methods described herein. The code when loaded into a general purpose computer transformed the general purpose computer into a special purpose computer that may in part be dedicated to the processing shown herein. In addition, the controller(s), computer, processor or dedicated hardware may be composed of at least one of a single processor, a multi-processor, and a multi-core processor.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for synchronization between video data and audio data in a mobile communication terminal, the method comprising:
acquiring Presentation Time Stamp (PTS) information for each of audio data and video data which need to be played simultaneously, the PTS information indicating a play time of the corresponding data;
determining a delay time between the terminal and a wireless device, the wireless device playing one data of the audio data and the video data;
generating new PTS information for the one data played by the wireless device by reflecting the determined delay time in the acquired PTS information; and
outputting the one data and the other data using the new PTS information for the one data and the acquired PTS information for the other data, respectively, wherein the one data and the other data are synchronized.

2. The method of claim 1, further comprising:
transmitting the one data to the wireless device and playing the other data synchronized in the terminal.

3. The method of claim 1, wherein the one data is the audio data and the other data is the video data.

4. The method of claim 1, wherein the determining of the delay time comprises:
transmitting a polling packet to the wireless device and measuring a time of transmission;
receiving a reply packet for the polling packet from the wireless device and measuring a time of reception; and
determining a difference between the measured time of reception and the measured time of transmission and dividing the difference by two.

5. The method of claim 1, wherein the new PTS information is generated by determining a difference between a play time indicated by the acquired PTS information and the determined delay time.

6. The method of claim 1, wherein the terminal and the wireless device support at least one technology of the group consisting of: Bluetooth, infrared communication (IrDA), and ZigBee.

7. An apparatus for synchronization between video data and audio data in a mobile communication terminal, the apparatus comprising:
a synchronizer for acquiring Presentation Time Stamp (PTS) information for each of the audio data and the video data, the PTS information indicating a play time of the corresponding audio data and video data, determining a delay time between the terminal and a wireless device that plays one data of the audio data and the video data, generating new PTS information for the one data by reflecting the determined delay time in the acquired PTS information, and synchronizing the one data and the other data using the new PTS information for the one data and the PTS information for the other data, respectively;
a wireless transceiver for transmitting the one data to the wireless device; and
a player for playing the other data in the terminal, wherein the one data and the other data are synchronized.

8. The apparatus of claim 7, wherein the one data is the audio data and the other data is the video data.

9. The apparatus of claim 7, wherein the synchronizer transmits a polling packet to the wireless device and measures a time of transmission, receives a reply packet in response to the polling packet from the wireless device and measures a time of reception, and determines a difference between the measured time of reception and the measured time of transmission and divides the difference by two.

10. The apparatus of claim 7, wherein the new PTS information is generated by determining a difference between a play time indicated by the acquired PTS information and the determined delay time.

11. The apparatus of claim 7, wherein the terminal and the wireless device support at least one technology of the group consisting of: Bluetooth, infrared communication (IrDA), and ZigBee.

12. The apparatus of claim 7, wherein the player is one of a speaker, an earphone, and a display unit.

13. A portable terminal comprising:
a wireless transmitter including an interface; and
a processor in communication with a memory, the memory including code which when accessed by the processor causes the processor to:
acquire PTS information associated with video data and audio data to be viewed, the PTS information providing timing information for outputting corresponding video data and audio data;
transmit, through the transmitter, a polling packet;
receive, through the transmitter, a reply packet in response to poll packet;
determine a delay time between a time of poll packet transmission and the time of receipt of the reply packet;
adjust the acquired PTS information timing based on the determined delay time; and
output one of the video data and the audio data at the acquired PTS information time and output the other one of the video data and the audio data at the adjusted PTS information time.

14. The portable terminal of claim 13, further comprising:
a display unit.

15. The portable terminal of claim 13, wherein the processor outputs one of the video data and the audio data through the transmitter at the adjusted PTS information time and the other of the video data and the audio data to the display unit at the acquired PTS information time.

16. The portable terminal of claim 13, wherein the transmitter supports at least one technology of the group consisting of: Bluetooth, infrared communication (IrDA), and ZigBee.

17. The portable terminal of claim 13, wherein the PTS information is acquired over a network.

18. The portable terminal of claim 13, wherein the PTS information is acquired with the video data and the audio data.
